(19) United States
(12) Patent Application Publication
(10) Pub. No.: US 2002/0120929 A1
(43) Pub. Date: Aug. 29, 2002

(54) Method and system for mass customization of digital television broadcasts

(76) Inventors: Eddie M. Schwalb, Irvine, CA (US); Lee M. Chen, Irvine, CA (US)

Correspondence Address: KIRTON AND MCCONKIE, 1800 EAGLE GATE TOWER, 60 EAST SOUTH TEMPLE, P O BOX 45120, SALT LAKE CITY, UT, 84145-0120, US

(21) Appl. No.: 09/796,190

(22) Filed: Feb. 28, 2001

(51) Int. Cl. H04N 7/025; H04N 7/10; G06F 3/00; H04N 5/445; G06F 13/00

(52) U.S. Cl. 725/32; 725/34; 725/35; 725/36; 725/46

(57) ABSTRACT

A method and system for the mass customization of Digital Television broadcasts that involves the broadcasting of synchronized sub-streams. Each sub-stream is divided into segments of equal length and marked by time-stamped tags. The sub-streams include keywords describing the video content, and the sub-stream keywords are compared with viewer keywords at the client-side set-top box to derive a match score. The set-top box then switches to the sub-stream having the best match score. Thus, the client-side set-top box can automatically select commercials that best fit the personal interests of each viewer, resulting in better targeted commercials and simultaneously benefitting the viewer and advertiser.

### BACKGROUND

1. Field of the Invention

The present invention relates generally to multimedia broadcast systems. More particularly, the present invention relates to methods for mass customization of Digital Television broadcasts.

2. Background Art

The advent of Digital Television (DTV) has added a new dimension to traditional television broadcasting by expanding the types of content that may be broadcasted along with standard program content. For example, digital technology allows software applications, such as applications providing television-based e-commerce capabilities, to be broadcasted through DTV broadcast signals. Digital technology also enables advances in the area of viewer-customized content. For instance, existing art gives a DTV content provider the ability to let viewers select to watch a movie in either a PG-rated version or in an R-rated version. This is done by broadcasting a digital combination of the PG- and R-rated movie versions which are then separated and prepared for viewing at a DTV broadcast receiver such as a set-top box situated at the viewer's location.

While digital technology has greatly expanded the horizons of the television broadcasting industry, existing art has not had the technology to allow the DTV industry to capitalize on the benefits of mass customization. However, the success of Internet as a result of its ability to customize advertising content according to individual consumer profiles or conduct shows the value of individual user-based customization. For example, major Internet-based entities such as Yahoo!® derive a significant portion of their revenue from the mass customization capabilities provided by Internet cookies. In this respect, the multimedia broadcasting industry in general, and terrestrial broadcasting in particular, is lagging behind the Internet industry. Thus, technology that would allow a single broadcast to be mass-customized-i.e., customized so that each individual viewer among the millions of television viewers could watch a broadcast tailored according to that individual viewer's preferences or profile-would be nothing short of invaluable.

### SUMMARY AND OBJECTS OF THE INVENTION

The present invention may be characterized generally as a software system that enables the mass customization of Digital Television broadcasts through the use of synchronized sub-streams. Basically, the sub-streams are divided into segments of equal length and marked by time-stamped tags. The sub-streams further include keywords describing the sub-stream video content, and the sub-stream keywords are compared with viewer keywords at a client-side broadcast receiver (e.g., at a set-top box) to derive a match score. The broadcast receiver then switches, at the appropriate synchronized time, to the sub-stream having the best match score. The result is a seamless display of a customized sequence of video segments. In the preferred embodiments of the present invention, this mass customization is achieved without sending individual viewer information back to the server.

Thus, the present invention provides a method for customizing a single uniform broadcast to fit the preferences of individual viewers. One practical application of the present invention results in the ability to mass customize commercials to best fit the personal interests of each viewer, further resulting in better targeted commercials and simultaneously benefitting the viewer and advertiser. In addition, this mass customization enables an arbitrary increase in broadcast advertisement time capacity, thereby further increasing the availability of a critical revenue source for broadcasters.

Accordingly, it is an object of some embodiments of the present invention to provide a Digital Television broadcasting system that enables the mass customization of a single broadcast without requiring communication back to the server.

Another object of some embodiments of the present invention is to provide a Digital Television broadcasting system having sub-streams divided into equal time regions so as to enable synchronized abrupt switching between sub-streams.

A further object of some embodiments of the present invention is to provide a Digital Television broadcasting system having sub-streams synchronized by time-stamped tags and marked by keywords so as to enable synchronized abrupt video changes customized according to viewer preferences.

Another object of some embodiments of the present invention is to provide a Digital Television broadcasting system that achieves mass customization of a single broadcast through the use of sub-streams, stream segment keywords, viewer profile keywords, time-stamped-tags, and synchronized abrupt changes.

Yet another object of some embodiments of the present invention is to provide a Digital Television broadcasting system that customizes displayed advertisements according to individual viewer preferences that are not communicated back to the server.

Another object of some embodiments of the present invention is to provide a Digital Television broadcasting system that attaches keyword information between consecutive time-stamped tags in every sub-stream.

Another object of some embodiments of the present invention is to provide a Digital Television broadcasting system that customizes the displayed broadcast through the use of keywords that indicate viewers' interests.

A further object of some embodiments of the present invention is to provide a Digital Television broadcasting system that determines which sub-stream to select for display by comparing keywords, calculating a quantitative degree of match, and displaying the sub-stream with the best match.

Yet another object of some embodiments of the present invention is to provide a Digital Television broadcasting system can create a customized advertisement stream.

A further object of some embodiments of the present invention is to provide a Digital Television broadcasting system that improves the viewer's experience by omitting ads not related to the viewer's interests.

Another object of some embodiments of the present invention is to provide a Digital Television broadcasting system that can automatically adjust a broadcast schedule to better fit a viewer's schedule.

Another object of some embodiments of the present invention is to provide a Digital Television broadcasting system that increases overall advertisement time and capacity.

These and other objects and features of the present invention will become more fully apparent from the following description, drawings, and the appended claims. Other objects will likewise become apparent from the practice of the invention as set forth hereafter.

### BRIEF DESCRIPTION OF THE DRAWINGS

The foregoing and other objects and features of the present invention will become more fully apparent from the accompanying drawings when considered in conjunction with the following description and appended claims. Although the drawings depict only typical embodiments of the invention and are thus not to be deemed limiting of the invention's scope, the accompanying drawings help explain the invention in added detail.

FIG. 1 illustrates the general environment of some embodiments of the present invention;

FIG. 2 illustrates a schematic diagram of the preferred embodiments of the broadcasted sub-streams of the present invention;

FIG. 3 illustrates a more detailed view of one embodiment of a single sub-stream segment;

FIG. 4 shows in more detail the timing and manner in which the switching between displayed sub-stream segments takes place in accordance with some embodiments of the present invention; and

FIG. 5 shows one embodiment of a matching algorithm employing keywords to determine which sub-stream to switch to for display.

### DETAILED DESCRIPTION OF EMBODIMENTS OF THE PRESENT INVENTION

The following detailed description, in conjunction with the accompanying drawings (hereby expressly incorporated as part of this detailed description), sets forth specific numbers, materials, and configurations in order to provide a thorough understanding of the present invention. In other instances, well-known features are omitted or simplified so as not to obscure the invention. However, the following detailed description in conjunction with the drawings will enable one skilled in the art to make and use the present invention even absent the omitted details.

The purpose of this detailed description being to describe the invention so as to enable one skilled in the art to make and use the present invention, the following description sets forth various specific examples, also referred to as “embodiments,” of the present invention. While the invention is described in conjunction with specific embodiments, it will be understood, because the embodiments are for explanatory purposes only, that this description is not intended to limit the invention to these particular embodiments. Indeed, it is emphasized that the present invention can be embodied or performed in a variety of ways; the detailed description and the drawings do not limit the scope of the invention because the substantive scope of the present invention is to be limited only by the appended claims. The drawings and detailed description are merely representative of particular embodiments of the present invention.

It should be noted that because some embodiments of the present invention are computer-implemented, the present invention includes embodiments that range from computer-executable instructions as part of computer readable media to hardware used in any or all of the depicted structures. Implementation may additionally be combinations of hardware and computer-executable instructions. For brevity, computer readable media having computer-executable instructions may also be referred to as “software” or “computer software.”

Reference will now be made in detail to several embodiments of the invention. The various embodiments will be described in conjunction with the accompanying drawings wherein like elements are designated by like alphanumeric characters throughout.

The present invention may be characterized generally as a software system that enables the mass customization of Digital Television broadcasts through the use of synchronized sub-streams. Basically, the sub-streams are divided into segments of equal length and marked by time-stamped tags. The sub-streams further include keywords describing the sub-stream video content, and the sub-stream keywords are compared with viewer keywords at a client-side broadcast receiver to derive a match score. The broadcast receiver then switches to the sub-stream having the best match score. One practical application of the present invention results in the ability to customize commercials to best fit the personal interests of each viewer, further resulting in better targeted commercials and simultaneously benefitting the viewer and advertiser. Morever, in the preferred embodiments of the present invention, all this is achieved without sending individual viewer information back to the server.

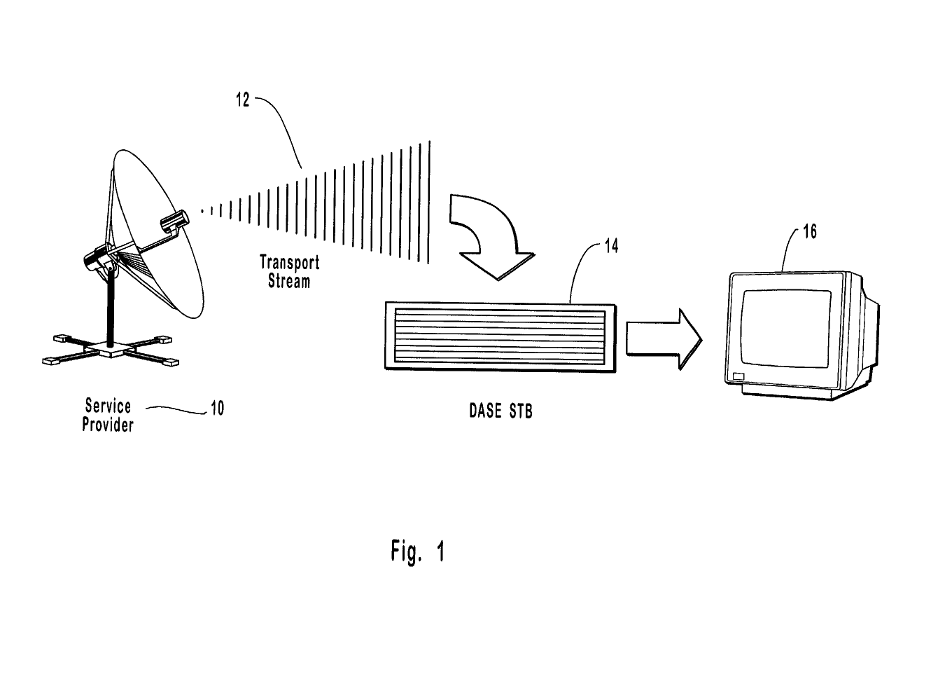

With reference now to the accompanying drawings, FIG. 1 shows the general environment of the present invention. A service provider 10, e.g., a television station program provider or Internet web site, transmits a broadcast or transport stream 12. The transport stream 12 is received by a client-side broadcast rendering device or receiver 14 (here shown as a set-top box) that is adapted to detect the transport stream 12 and prepare the content therein for display on a client-side display 16. The display can be any sort of suitable television display, including a wide screen TV, a flat screen TV, an HDTV, or a computer monitor.

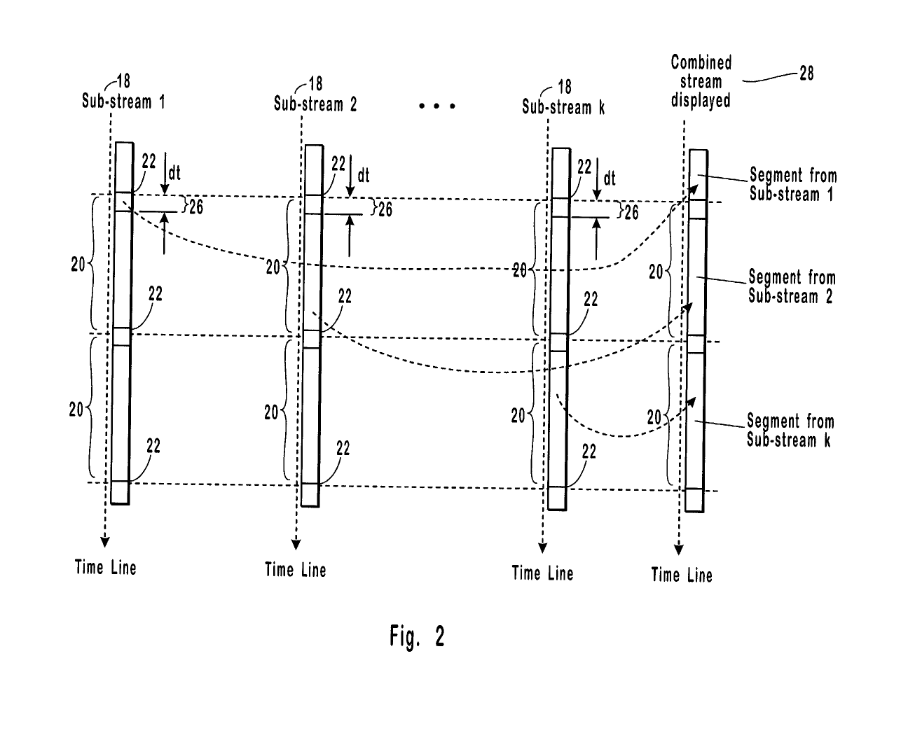

The transport stream 12 comprises multiple sub-streams or sub-channels 18 (shown in detail in FIG. 2) that contain various types of audio, video, and data content including, but not limited to, television and cable programs, commercial advertisements, web content, stock reports, telephone directories, and electronic coupons that an attached computer can print out. In the preferred embodiments of the present invention, the sub-streams 18 are multiplexed together in the transport stream 12 in accordance with the MPEG format of the Advanced Television Systems Committee (ATSC). There are several ways to encode and compress transport streams into MPEG format, and these methods are well known to those skilled in the art. However, the preferred embodiments of the present invention employ an MPEG format that enables the broadcast delivery of alternative media segments to the receiver 14 without a separate broadcast channel for the alternative segments, and without a need for an upstream channel for the receiver 14 to indicate which alternative media segment to view.

With reference now to FIG. 2, shown is a schematic diagram of the preferred embodiments of the broadcasted sub-streams 18 of the present invention. In the preferred embodiments, each individual sub-stream 18 is divided into consecutive time regions or segments 20 of equivalent length. The sub-streams 18 are time-stamped at the beginning of each time region 20 by a tag 22. Such tags 22 are well known in the art and typically comprise a fixed number of bits (e.g., 33 bits) representing time stamps. In the present invention, the tags 22 provide sufficient information so as to enable the practice of the present invention as further described herein.

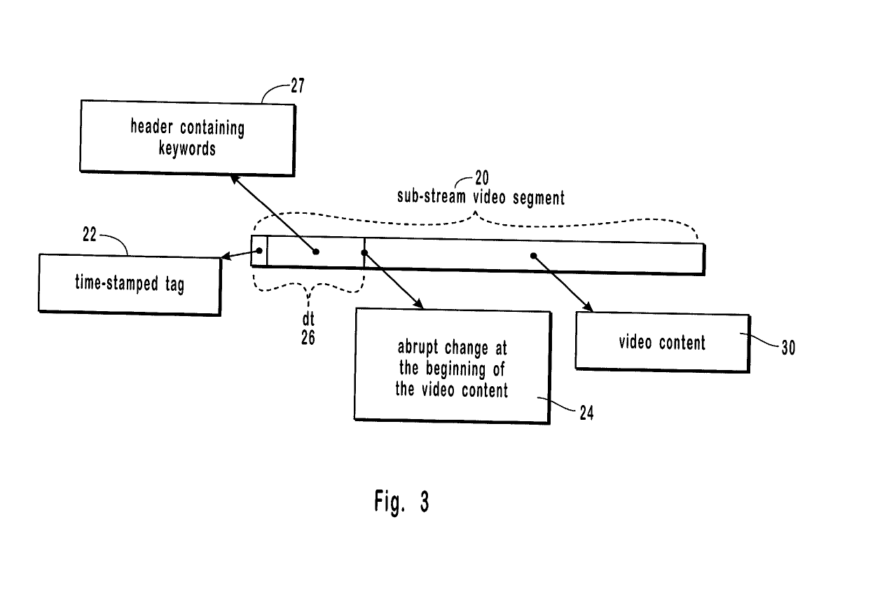

Each sub-stream 18, in the preferred embodiments of the present invention, further contains an abrupt change 24 exactly dt seconds following each time-stamped tag 22. In other words, each sub-stream segment or region 20 begins with a time-stamp 22, following which is a short segment 26 of length dt seconds. The end of the dt segment 26 marks the point where the abrupt change 24 in the video stream 18 takes place. FIG. 3 shows a more detailed view of a single sub-stream segment 20. Here, the dt segment 26 is shown to further include a header 27 and video content 30 following the header 27. The header 27 contains information such as keywords indicating the content type of the video content 30 contained in the sub-stream segment 20.

In the preferred embodiments of the present invention, the content of only one of the sub-streams 18 can be rendered on the client-side display 16 at a time. FIG. 2 thus shows a combined stream 28, the video stream that is actually displayed on the display 16. As can be seen in the drawings, combined stream 28 comprises segments 20 from various sub-streams 18. Note that it is within the scope of the present invention to provide two or more combined streams 28 on the display 16 such as in a picture-in-picture display.

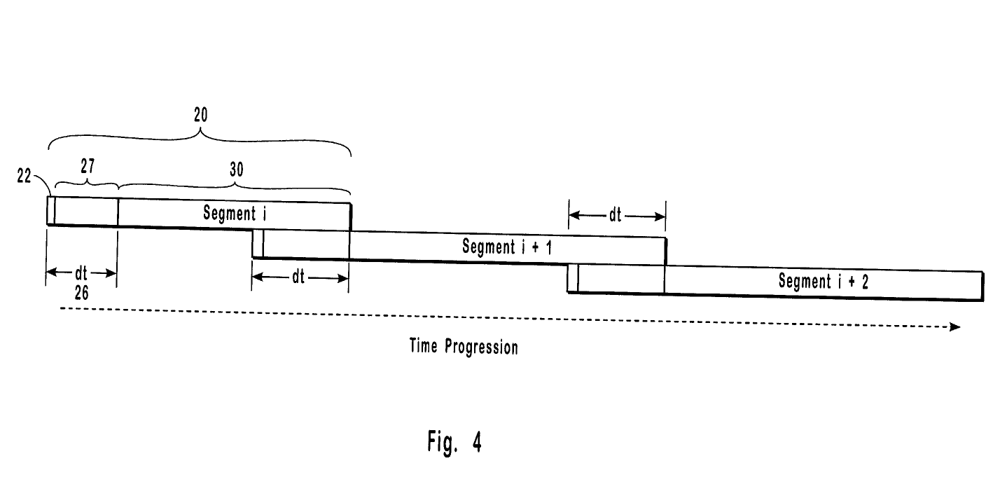

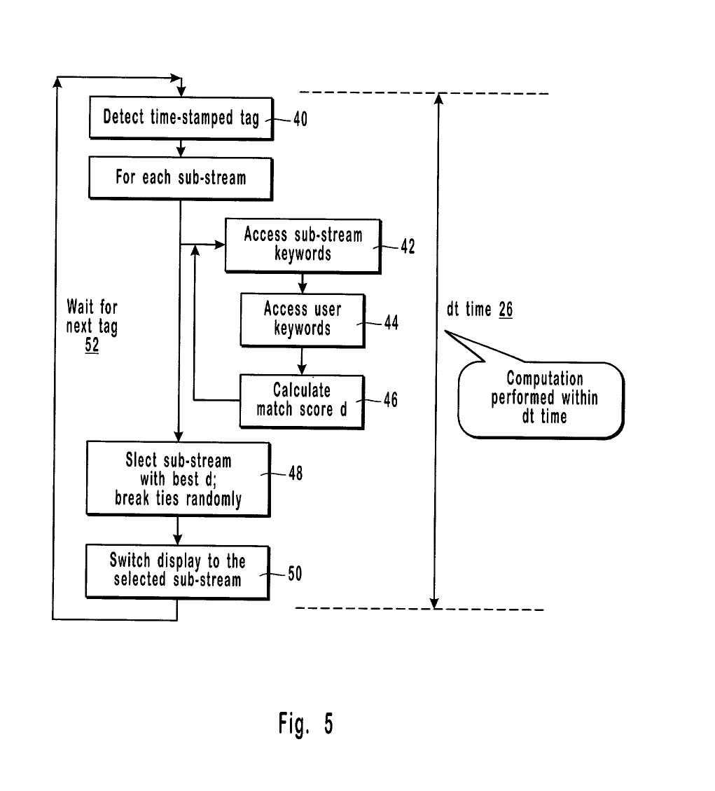

FIG. 4 illustrates in more detail the timing and manner in which the switching between displayed sub-stream segments 20 takes place. In the preferred embodiments of the present invention, the switching between the segments 20 is timed so that the header of segment i+1 overlaps the end of the content of the previous segment, segment i. The time between the transmittal of the time-stamped tag 22 and the beginning of the video content 30 of the subsequent sub-stream segment 20 is preferably dt seconds so that an algorithm of the present invention, discussed below in conjunction with FIG. 5, has sufficient time to execute. The switching between segments 20 is seamless to the viewer because all switching between sub-streams 18 takes place at the points of abrupt change 24. This sub-stream design-i.e., the division of the streams 18 into time-stamped regions 20 of equivalent length-allows the sub-streams 18 to be synchronized in order to achieve the mass customization of the present invention.

Turning now to FIG. 5, shown is an exemplary algorithm that employs keywords to determine which sub-stream 18 to switch to at the points of abrupt change 24. In the preferred embodiments of the present invention, when the time-stamped tag 22 is detected 40, sub-stream keywords, contained (as noted above) in the header 27 of each sub-stream segment 20 of each sub-stream 18, are accessed 42 to determine the video content 30 of the associated sub-stream segment 20. The sub-stream keywords are tagged to the sub-stream segments 20 by means known in the art and may provide various information about the associated sub-stream segments 20. At a minimum, these sub-stream keywords preferably describe the content 30 of the sub-stream segment 20. For example, in the case of content 30 that is advertising content, the sub-stream keywords can identify content as “sports ads,” “ads directed to women,” “food ads,” etc. In the case of content 30 that is standard program content, the sub-stream keywords can identify the type of program by categories such as “comedy,” “sports,” “adventure,” “game show,” etc. In the preferred embodiments of the present invention, each sub-stream 18 that carries advertising content is designated to carry one category of advertising content. For example, one sub-stream 18 may be designated to carry the sports ads, another sub-stream 18 the food ads, and so forth. In another alternative, one or more sub-streams 18 may be designated to carry all categories of advertising content.

After the sub-stream keywords are accessed 42, viewer keywords are accessed 44. These viewer keywords indicate the individual viewer's preferences or profile and are preferably located on a client-side device that is operatively coupled to the broadcast receiver 14. For example, in the preferred embodiments, the viewer enters keywords (e.g., through selecting from a list of selections displayed on the display 16) that represent his or her preferences or interests. The viewer who wishes to view a comedy might select “comedy” from a list presented on the display 16 using a user input device such as a remote control. Alternatively or additionally, the viewer keywords may represent a viewer profile that is automatically generated as a consequence of user input-similar to the manner in which Internet cookies can gather user information. For example, when the viewer selects a certain type of program to watch, the broadcast receiver 14, or other device operatively coupled to the broadcast receiver 14, may store one or more viewer keywords 44 corresponding to or relating to the viewer's selection. However, in the preferred embodiments of the present invention, the viewer keywords are not sent back to the originating server. Thus, the preferred embodiments are able to customize broadcasts without requiring a viewer login procedure and without communicating personal viewer information to the server, thereby protecting the privacy of viewers by not disclosing to the broadcaster the viewer preferences or the specific broadcast combination displayed on display 16.

In some embodiments of the present invention, a return channel (not shown) containing viewer preference information or keywords is used to enable the broadcaster and the advertisers to obtain statistic market reach information. However, these embodiments having a return channel are not the preferred embodiments because they eliminate the above-mentioned advantage of protecting viewer privacy.

As shown in FIG. 5, once the sub-stream keywords are accessed 42 and the viewer keywords are accessed 44, the two types of keywords are compared by calculating 46 a match score, here designated as “d.” In one embodiment, match score d is a quantitative value representative of the degree of match between the sub-stream keywords and the viewer keywords. For example, the values of d might be assigned to range between 0 and 1, where 1 indicates a perfect match and 0 indicates no match. It is contemplated that the match score d is to be calculated by means known in the art such as by web search engine technology that allows users to pull up a list of various web sites upon the entering of one or more keywords.

Once the match scores for all the sub-streams 18 are compared, in some embodiments, the sub-stream producing the best match is selected, causing the display of the currently displayed sub-stream to break 48 at the point of abrupt change 24. Subsequently, the display 16 is switched 50 to show the selected sub-stream. Thereafter, the receiver 14 waits 52 for the next tag and repeats the process just described in conjunction with FIG. 5.

Note that various methods may be employed by the present invention to determine which sub-stream 18 to switch to. In some embodiments, instead of switching to the sub-stream 18 with the “best” match value, switching may be determined by a designated threshold value. For example, a threshold match value may be designated, and the first sub-stream 18 to produce a match score meeting that threshold value will be the sub-stream 18 to be displayed on the display 16.

In the preferred embodiments, the time dt is a fixed time that is long enough so as to allow the keyword matching algorithm of the present invention to take place before the receiver 14 receives the point of the abrupt switch 24. Consequently, segment switching occurs dt seconds (or the equivalent, in terms of sub-stream frames) after the receiver 14 receives the time-stamped tag 22.

The stream displayed 28 on the television display 16 thus contains a seamless assembly of video segments from numerous broadcasts. Theoretically, the total number of distinct customized streams 28 that can be assembled from k sub-streams 18, each sub-stream 18 having n segments 20 and n+1 tags 22, is kⁿ. Therefore, the total number of custom broadcasts grows exponentially with the number of sub-stream segments n and the number of individual sub-streams k.

Accordingly, the present invention enables the mass customization of a television broadcast in that it can customize a single broadcast for each individual viewer so that each viewer views a broadcast sequence tailored according to that individual's preferences. For example, the mass customization capability of the present invention effectively increases advertisement time capacity significantly. In particular, during program live broadcast time, it is customary to dedicate predetermnined time intervals, e.g., 30 seconds, to advertisements. Thus, if the sub-streams 18 are such that the switch between commercials is always marked by time-stamped tags 22 in accordance with the present invention, a customized advertisement sequence can be produced that best matches the individual preferences of the viewer. One particular viewer's display might thus show health-related ads; another might show parenting-related ads; yet another might display sports-related ads. As a result, any one of the commercials positioned within one of k number of sub-streams 18 is potentially viewable by viewers, thereby increasing the total number of viewable commercials by a factor of k.

In another example, the mass customization capability of the present invention enables the viewing of a program displayed to best fit the interests of the viewer at any given time. In particular, a viewer who is interested in a specific comedy can be presented with that comedy if it is available on one of the sub-streams 18. If another viewer with a separate display 16 simultaneously wishes to view a conflicting program, e.g., the news, the present invention enables the latter viewer's display 16 to switch to the news.

In some embodiments of the present invention, the methods of the present invention can be incorporated into a hierarchical video stream merging apparatus, whereby the merged stream contains multiple sub-streams, each customized to contain local content such as local advertisements or favorite shows. In some embodiments, the methods of the present invention may be employed by means of a card for a personal computer that turns the computer into a set-top box of sorts. Such a card accepts and decodes ATSC signals for feeding to a DTV.

Indeed, it is emphasized that the present invention may be embodied in various specific forms without departing from the scope of the present invention. For example, the type of digital encoding format of the broadcasted digital stream is immaterial to the present invention. As another example, High Definition Television (HDTV) broadcasts come within the scope of the present invention as well as standard DTV broadcasts. Also, the present invention may be operable in both wired and wireless environments.

Hence, the present invention provides a method and system for the mass customization of Digital Television broadcasts through the use of synchronized sub-streams. In practical application, the present invention can automatically select commercials that best fit the personal interests of each viewer, resulting in better targeted commercials while simultaneously benefitting the viewer and advertiser. The present invention can improve the viewer's experience by omitting ads not related to the viewer's interests as well as by automatically adjusting a broadcast schedule to better fit a viewer's schedule. In addition, this mass customization enables an arbitrary increase in broadcast advertisement time capacity, thereby further increasing the availability of a critical revenue source for broadcasters. Morever, in the preferred embodiments of the present invention, all this is achieved without sending individual viewer information back to the server.

It is again underscored that the present invention may be embodied in other specific forms without departing from its spirit or essential characteristics. The described embodiments herein should be deemed only as illustrative. Indeed, the appended claims indicate the scope of the invention; the description, being used for illustrative purposes, does not limit the scope of the invention. All variations, alternatives, modifications, and equivalents that come within the meaning and range of equivalency of the claims are to be embraced within the scope of the claims.

What is claimed is:

1. A method for the mass customization of digital television broadcasts comprising:
receiving a digital television broadcast comprising a plurality of synchronized sub-streams wherein said sub-streams are divided into segments of equal length, and wherein each of said segments are time-stamped and comprise sub-stream keywords indicative of the content of said segments;
accessing said sub-stream keywords;
accessing viewer keywords;
comparing said sub-stream keywords and said viewer keywords;
deriving a match score from said comparing of said keywords;
based on the value of said match score, selecting one of said segments for presentation on a display; and
switching to the selected segment at a point of abrupt change within said broadcast.

2. The method of claim 1 wherein said sub-streams are multiplexed in accordance with MPEG format.

3. The method of claim 2 wherein said sub-stream keywords are contained in a header within said segments.

4. The method of claim 3 wherein said segments further comprise a segment of fixed time length dt.

5. The method of claim 4 wherein said steps of comparing, deriving, selecting, and switching all take place within said time dt.

6. The method of claim 5 wherein said viewer keywords comprise viewer-entered preferences.

7. The method of claim 5 wherein said viewer keywords comprise a viewer profile.

8. The method of claim 5 wherein said step of selecting is based on determining the best match score.

9. The method of claim 5 wherein said step of selecting is based on determining whether said match score meets a threshold value.

10. The method of claim 6 wherein each of said sub-streams carries advertising content and is designated to carry one category of advertising content.

11. The method of claim 1 wherein said step of accessing viewer keywords does not require a separate broadcast channel designated for alternative sub-stream segments nor an upstream channel designated for transmitting information as to what alternative segment to view.

12. The method of claim 1 wherein said viewer keywords are transmitted through a return channel back to the broadcaster.

13. The method of claim 1 wherein said sub-streams each carry any category of advertising content.

14. The method of claim 1 wherein said display is an HDTV.

15. The method of claim I wherein said display is a picture-in-picture display.

16. The method of claim I wherein said digital television broadcast is broadcast by an Internet provider.

17. A method comprising:
receiving a digital television broadcast comprising a plurality of synchronized sub-streams wherein said sub-streams are divided into segments of equal length, and wherein each of said segments further comprise time stamps as well as sub-stream keywords indicative of the content of said segments;
reading said time stamps;
accessing said sub-stream keywords;
accessing viewer-entered keywords;
comparing said sub-stream keywords and said viewer-entered keywords;
deriving a match score from said comparing of said keywords;
based on the best value of said match score, selecting one of said segments for presentation on a display; and
switching to the selected segment at a point of abrupt change within said broadcast, wherein the time elapsed between said step of reading and said step of switching is less than a fixed amount of time dt.

18. A method comprising:
broadcasting a plurality of synchronized sub-streams;
receiving a digital television broadcast comprising said plurality of synchronized sub-streams wherein said sub-streams are divided into segments of equal length, and wherein each of said segments further comprise time stamps as well as sub-stream keywords indicative of the content of said segments;
reading said time stamps;
accessing said sub-stream keywords;
accessing viewer keywords;
comparing said sub-stream keywords and said viewer keywords;
deriving a match score from said comparing of said keywords;
based on the value of said match score, selecting one of said segments for presentation on a display that displays a combined stream comprising segments from said sub-streams; and
switching to the selected segment at a point of abrupt change within said broadcast, wherein the time elapsed between said step of reading and said step of switching is less than a fixed amount of time dt.

19. The method of claim 18 wherein said sub-streams are multiplexed in accordance with MPEG format.

20. The method of claim 18 wherein said viewer keywords comprise viewer-entered preferences.

21. The method of claim 18 wherein said viewer keywords comprise a viewer profile.

22. The method of claim 18 wherein said step of selecting is based on determining the best match score.

23. The method of claim 18 wherein said step of selecting is based on determining whether said match score meets a threshold value.

24. The method of claim 18 wherein each of said sub-streams carries advertising content and is designated to carry one category of advertising content.

25. A method comprising:
entering keywords into a broadcast rendering device coupled to a display; and
viewing a customized digital television broadcast on said display wherein said customized broadcast comprises a combined stream, said combined stream comprising segments of equal length and originating from a plurality of synchronized sub-streams, said segments further comprising time stamps as well as sub-stream keywords indicative of the content of said segments, said segments of said combined stream being determined by a matching algorithm that compares said sub-stream keywords and said viewer-entered keywords.

26. A system comprising:
a plurality of digital television broadcast sub-streams comprising segments of equal length, said segments each beginning with a time stamp and having a point of abrupt change at dt seconds after the time stamp;
a plurality of sub-stream keywords indicative of the content of said segments, said sub-stream keywords being contained within said sub-streams;
a plurality of viewer keywords representing viewer preferences;
a broadcast rendering device for receiving said broadcast sub-streams and said viewer keywords, said broadcast rendering device performing a comparison between said sub-stream keywords and said viewer keywords and, based upon a match score that said rendering device determines from said comparison, selecting one of said segments for presentation within a combined stream, said presentation occurring at said point of abrupt change; and
a display coupled to said broadcast rendering device for displaying said combined stream.

27. The system of claim 26 wherein said sub-streams are multiplexed in accordance with MPEG format.

28. The system of claim 26 wherein said sub-stream keywords are contained in a header within said segments.

29. The system of claim 26 wherein said viewer keywords comprise viewer-entered preferences.

30. The system of claim 26 wherein said viewer keywords comprise a viewer profile.

31. The system of claim 26 wherein said step of selecting is based on determining the best match score.

32. The system of claim 26 wherein said step of selecting is based on determining whether said match score meets a threshold value.

33. The system of claim 26 wherein each of said sub-streams carries advertising content and is designated to carry one category of advertising content.

34. The system of claim 26 wherein said sub-streams each carry advertising content or any category.

35. The system of claim 26 wherein said viewer keywords are transmitted through a return channel back to the broadcaster.

36. The system of claim 26 wherein said display is an HDTV.

37. The system of claim 26 wherein said display is a picture-in-picture display.

38. The system of claim 26 wherein said digital television broadcast is broadcast by an Internet provider.

39. The system of claim 26 said broadcast rendering device is a set-top box.

40. The system of claim 26 further comprising a hierarchical video stream merging apparatus whereby said combined stream comprises multiple sub-streams each customized to contain local content comprising local advertisements.

41. The system of claim 26 further comprising a hierarchical video stream merging apparatus whereby said combined stream comprises multiple sub-streams each customized to contain local content comprising favorite shows.

42. The system of claim 26 wherein the total number of possible variations of said combined streams grows exponentially with the number of sub-stream segments and the number of individual sub-streams.

43. A system enabling the mass customization of a DTV broadcast without sending viewer information back to the server, and wherein the total number of custom broadcasts of said system grows exponentially with the number of broadcast sub-streams and sub-stream segments, said system comprising:
a plurality of digital television broadcast sub-streams transmitted by a television service provider, said sub-streams being multiplexed in accordance with MPEG format, said sub-streams comprising segments of equal length, said segments each beginning with a time stamp that is followed by a point of abrupt change dt seconds after the time stamp, said point of abrupt change being followed by a header, said header being followed by video content;
a plurality of sub-stream keywords indicative of the content of said segments, said sub-stream keywords being contained within said header of said sub-streams;
a plurality of viewer-entered keywords representing viewer preferences;
a set-top box that receives said broadcast sub-streams and said viewer-entered keywords, said set-top box being also configured to perform a comparison between said sub-stream keywords and said viewer-entered keywords and, based upon a best match score that said set-top box determines from said comparison, select one of said segments for presentation within a combined stream, said presentation occurring at said point of abrupt change; and
a display coupled to said set-top box for displaying said combined stream.
